(19) United States
(12) Patent Application Publication
(10) Pub. No.: US 2023/0263692 A1
(43) Pub. Date: Aug. 24, 2023

(54) MOBILITY AND STABILIZATION CADDY

(71) Applicant: Proactive Comfort, LLC, Chantilly, VA (US)

(72) Inventor: Carole Purdue, Grasonville, MD (US)

(21) Appl. No.: 18/171,866

(22) Filed: Feb. 21, 2023

Related U.S. Application Data
(60) Provisional application No. 63/312,570, filed on Feb. 22, 2022.

(51) Int. Cl. A61H 3/04

(52) U.S. Cl. CPC A61H 3/04; A61H 2003/004

(57) ABSTRACT

A tip resistant mobility and stabilization caddy includes an annular grip capable of being grasped by one hand of a patient at any point along its 360° periphery to permit stable transfer of the patient between sitting and standing positions and render the caddy easily manipulated by the patient when walking. A plurality of at least four equiangularly spaced legs extend between an upper table plate and a lower ballast plate, and a plurality of wheels secured at the lower ends of respective legs. A lighting element is actuable manually or automatically in response to motion to illuminate the floor around the caddy.

### CROSS REFERENCE TO RELATED APPLICATIONS

This application is a non-provisional application claiming priority from U.S. Provisional Application No. 63/312,570, entitled “Mobility Cart”, and filed Feb. 22, 2022, the disclosure in which is incorporated in its entirety herein by this reference.

### TECHNICAL FIELD

The present disclosure pertains generally to mobility assistive caddies for persons susceptible to falls, such as elderly persons and persons with balance issues. More particularly, the disclosure pertains to a wheeled table that provides stable support for a person while rising from a bed or chair and during subsequent ambulation.

### BACKGROUND OF THE DISCLOSURE

According to the Centers for Disease Control and Prevention, three million older adults are treated in emergency departments for injuries resulting from falls each year, and over three hundred thousand are hospitalized for hip fractures. More than 95% of all hip fractures are caused by falls, and 90% of falls occur in bathrooms. In 2015, the medical costs for falls totaled more than fifty billion dollars, and Medicare and Medicaid covered 75% of these costs. These facts justify the development of innovative devices designed to keep people stably on their feet and reduce the risk of falling.

There are different types of prior art mobility assistive devices, each having one or more disadvantages. Most notable is the ubiquitous walker, typically with two wheels, sometimes with four, examples of which are disclosed in U.S. Pat. No. 5,692,762 (Obitts), U.S. Pat. No. 7,871,088 (Silva et al) and US20110315177 (McGann et al). The conventional walker is difficult to steer, is laterally unstable and subject to tipping to either side, and is known to cause damage to furniture and other surroundings when moved through tight spaces due to limited steerability. In addition, a person who needs the walker when rising from a bed at night in a dark environment may have trouble finding and properly positioning the walker for stable rising and then walking with it in the dark environment with furniture or other objects in that person's path.

Another type of mobility device is disclosed in U.S. Ser. No. 10/299,875 (Schoenig et al) which is intended for patients who are necessarily connected to medical components, such as infusion pumps, IV fluid containers, etc. The requirement for transporting these medical components with the patient renders the device more structurally complex and expensive than is necessary for persons having no need for transporting medical components but who need balance support while walking. In addition, the Schoenig et al type of device has the same troublesome issues that plague conventional walker units when used in a darkened environment.

Accordingly, there is a need for a stable and inexpensive mobility device for persons requiring balance assistance while rising from a seated position and while walking, which device can be readily manipulated in use to avoid damaging furniture and other items and can be used safely in a dark environment. The present disclosure addresses that need.

### SUMMARY

This Summary is provided to introduce a selection of concepts in a simplified form that are further described below in the Detailed Description. This Summary is not intended to identify key or essential features of the claimed subject matter, nor is it intended as an aid in determining the scope of the claimed subject matter.

The apparatus disclosed herein is a tip resistant mobility and stabilization caddy having a grip capable of being grasped by the hand of a patient at any point along its 360° periphery and that is easily manipulated by the patient when walking. In one aspect the mobility and stabilization caddy comprises a plurality of at least four angularly spaced legs having upper and lower ends, an upper table plate secured to the upper ends of the legs and having top and bottom surfaces and a peripheral edge, a plurality of wheels, each wheel secured at the lower end of a respective leg, and a grip secured to the table plate in radially outward spaced relation to and surrounding the peripheral edge of the plate. In another aspect the caddy may be provided with a lighting element that may be actuated manually or automatically in response to motion to illuminate the floor around the caddy for patient safety. In further aspects the wheels may be easily directionally manipulated in unison by the patient grasping the grip and simply moving his/her wrist or arm to directionally orient the caddy. In a still further aspect, a lower ballast plate is provided vertically spaced below the table plate and secured to the lower ends of the legs to provide the caddy with a low center of gravity. The table plate may have a non-slip upper surface to permit stable transport of objects placed thereon, and a cup holder may be provided on that surface.

### BRIEF DESCRIPTION OF THE DRAWINGS

The above mentioned and other features of the disclosed mobility caddy will become more apparent and better understood by reference to the following description of an embodiment of considered in conjunction with the accompanying photos in which:

FIG. 1 is a perspective view from above of one embodiment of a stabilization and mobility caddy employing the principles disclosed herein.

FIG. 2 is a top view in plan of the embodiment of FIG. 1.

FIG. 3 is side view in elevation of the embodiment of FIG. 1.

FIG. 4 is a detail view in perspective showing one possible wheel that may be used on a stabilization and mobility caddy according to the principles disclosed herein.

FIG. 5 is a detail view in perspective of an alternative wheel that may be used on a stabilization and mobility caddy according to the principles disclosed herein.

FIG. 6 is a view in perspective from above of another embodiment of a stabilization and mobility caddy employing the principles disclosed herein.

FIG. 7 is a view in perspective from below of the upper portion of the stabilization and mobility caddy of FIG. 6.

FIG. 8 is a detail view in perspective showing a light switch that may be provided on a stabilization and mobility caddy according to the principles disclosed herein.

FIG. 9 is a view in perspective from above of still another embodiment of a mobility caddy employing the principles disclosed herein.

FIG. 10 is a view in perspective from above of yet another embodiment of a stabilization and mobility caddy employing the principles disclosed herein.

FIG. 11 is a view in perspective from above of a further embodiment of a stabilization and mobility caddy employing the principles disclosed herein.

FIG. 12 is a detail view in perspective of the wheels used in the embodiment of FIG. 11.

### DETAILED DESCRIPTION OF THE DRAWINGS

The present embodiments will now be described more fully below with reference to the accompanying drawings, in which exemplary embodiments are shown. It will be readily understood that the components of the embodiments as generally described herein and illustrated in the appended figures could be arranged and designed in a wide variety of different configurations. Thus, the following more detailed description of embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this description to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

The relative terms “top”, “bottom”, “vertical”, ‘orizontal”, “upper’, “lower” “above”, “below”, “forward”, “rear”, “height”, “length”, “width”, “thickness”, and the like as used herein are for ease of reference in the description to merely describe points of reference and are not intended to limit any particular orientation or configuration of the described subject matter.

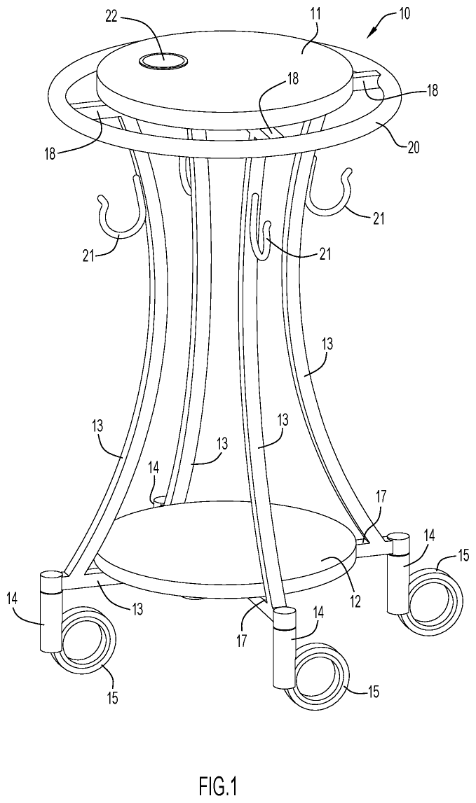

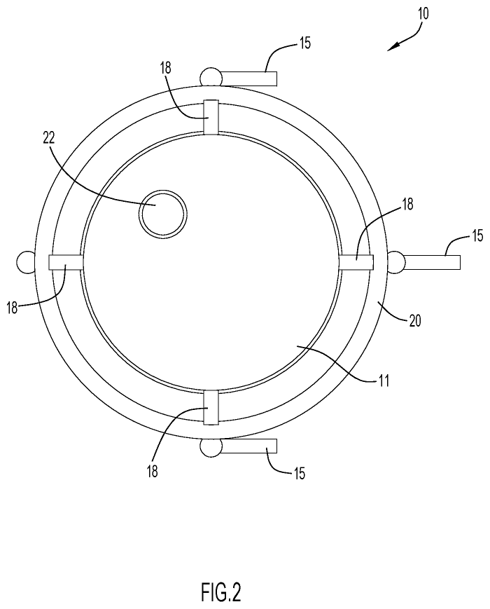

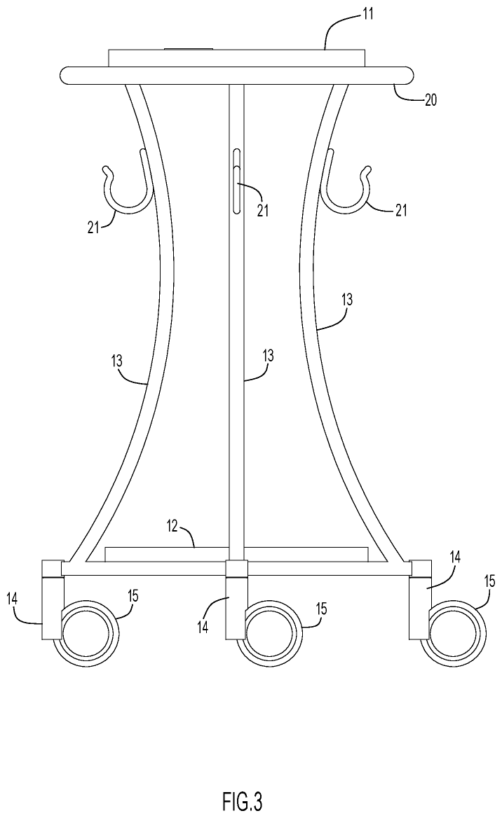

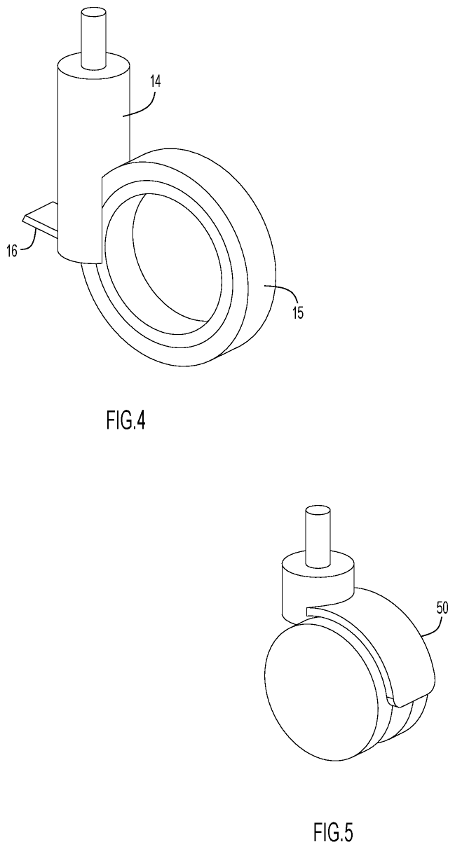

Referring specifically to FIGS. 1-4 of the accompanying drawings, a mobility and stabilization caddy 10 comprises a circular upper table plate 11 having top and bottom surfaces and an annular peripheral edge and a circular lower ballast plate 12 structurally joined by four legs 13 that are equiangularly spaced about a central longitudinal axis of the caddy extending between the centers of plates 11 and 12. Plates 11 and 12 may be substantially the same size and are configured to be in parallel horizontal planes when the caddy is in use. Legs 13 are longitudinally arcuately bent convexly toward one another and, in the illustrated embodiment, are configured as hollow steel bars with a square cross-section. The lower end of each leg 13 is rigidly secured to a respective arm 17 which is rigidly secured to and extends radially outward from the underside of ballast plate 12 to provide a stable connection of each leg to plate 12. Arms 17 are equiangularly spaced about the central longitudinal axis of the caddy. In addition, the lower end of each leg 13 terminates in a respective self-braking caster assembly 14, for example of the type that is responsive to applied weight to prevent inadvertent rotation of its dependent wheel 15. Caster assembly 14 includes a stem that is freely pivotable 360° about a respective vertical caster axis. Each wheel 15 is rotatable about its respective central horizontal axis to permit the caddy 10 to be easily rolled along a floor or other surface. For some embodiments the caster assembly may include a foot-actuable pedal brake 16 (best viewed in FIG. 4) to permit selective inhibiting of rotation of its wheel 15. Other types of caster assemblies may be used and serve the same purpose as caster assembly 14. For example, a self-braking twin wheel caster assembly 50 of the type illustrated in FIG. 5 may be alternatively employed.

The upper end of each leg 13 is rigidly secured to a respective radially extending arm 18 which is rigidly secured to and extends radially outward from the underside of table plate 11 to provide a rigid connection of each leg 13 to plate 11. Arms 18 are equiangularly spaced about the central longitudinal axis of the caddy and are equal in number to the number of legs 13. The outer ends of arms 18 terminate at and are rigidly secured to an annular grip 20 disposed concentrically about the central longitudinal axis of caddy 10 at a location radially beyond the periphery of plate 11, and at a level the same as or slightly lower than the underside or bottom surface of that plate. The radial spacing between grip 20 and table plate 11 is sufficient to permit a user to have his/her fingers be comfortably spaced from plate 11 when grasping grip 20. Grip 20 may be a hollow cylindrical tube having an outer diameter that is smooth and easily surrounded and gripped by a user's hand. The radially outer extremity of grip 20 extends from the caddy central longitudinal axis at least as far as, or slightly farther than, the radially outer extremities of the caster wheel assemblies.

Each leg 13, on its radially outward facing concave surface at a vertical location just below table plate 11 and grip 20, has secured thereto a respective hook 21 on which a user may hang and transport personal belongings or medical equipment such as oxygen tubing, Foley bags, wound VACS, etc. The legs 13 thusly serve to: secure plates 11 and 12 to one another in vertically spaced relation; support the wheels 15; and support hooks 21. It will be appreciated that to provide these functions, legs 13 need not be lengthwise arcuate or hollow, and need not have a square transverse cross-section; that is, the legs may, for example, be substantially straight lengthwise, solid and have round our polygonal cross-sections. Likewise, although the preferred configuration of plates 11 and 12 is circular, they may be polygonal and still serve the intended purpose.

Table plate 11 preferably has a flat, non-slip top surface, suitable for transporting items such as plates of food. A built-in cup holder 22 may be defined as a recess in the top surface, or as a through hole in the plate 11, to permit safe transport of beverages. By way of example, in one suitable embodiment plate 11 had a diameter of approximately nineteen inches and its top surface was positioned approximately thirty-two inches above the floor. In a smaller embodiment, suitable for shorter users, plate 11 had a diameter of approximately seventeen inches and its top surface was positioned approximately twenty-eight inches above the floor

Caddy 10, including the plates 11 and 12, legs 13, and grip 20, is preferably made of steel and weighs at least twenty-five pounds, and preferably more. Compared to other ambulation-assistive devices that are fabricated from relatively lightweight aluminum, the greater weight of caddy 10 resists lateral tipping forces more effectively. Also important in resisting tipping is steel ballast plate 12 located near the lower end of the caddy, a few inches above the floor in use, which provides caddy 10 with a low center of gravity.

The annular cylinder configuration of grip 20 permits it to be grasped anywhere along its circumferential length so that caddy 10 can be pushed or pulled in any direction in a 360° range about its central longitudinal axis. This feature particularly benefits persons who have spatial awareness deficits, such as those suffering from Parkinson's disease, stroke, or dementia. The rounded overall design of the caddy permits it to be easily maneuvered in tight spaces without impacting or getting caught on furniture; i.e., the user can grasp different parts of the grip 20 to move the caddy in any direction. This feature of 360° graspability is also advantageous for users to move safely from a standing to a seated position.

The self-braking caster assembly permits the caddy to be locked in place when not in use. A user needs only to apply horizontal force in any direction via grip 20 to unlock the brakes, permitting the wheels to roll freely and the caddy to move accordingly.

If pedal brakes 16 are provided on the caster assemblies, the caddy may be safely locked in place for assisting stable transfer of the user between a standing position and a seated position on a bed, chair or toilet.

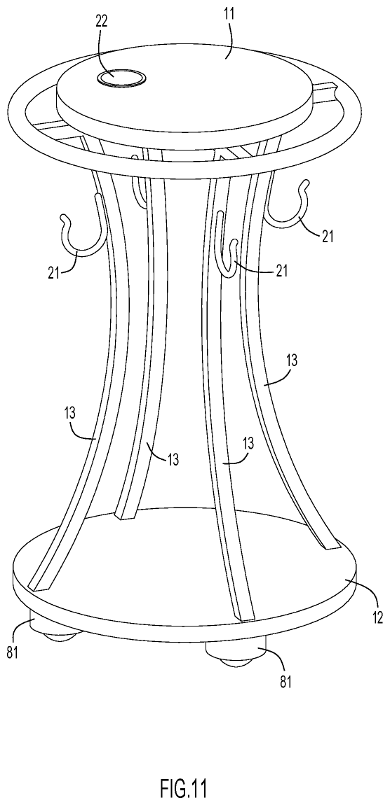

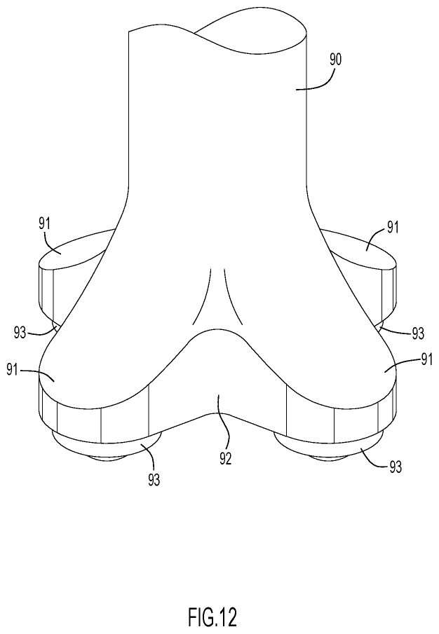

Wheels 15 are small diameter thin wheel tire-type wheel of annular configuration with an annular polyurethane peripheral tread, and caster assembly 14 is a swivel stem caster. It will be appreciated that different types of wheels and caster assemblies may be used for caddy 10 without departing from the principles described. For example, a twin wheel caster assembly 50 shown in FIG. 5 may be used, as may the twin wheel caster assembly shown in U.S. Pat. No. 4,333,207 (Atwood), the entire disclosure in which is incorporated herein by reference. Alternatively, the caster assembly may be of the omnidirectional roller ball type disclosed in US20020070514 (Costa et al) and U.S. Pat. No. 3,379,454 (Woodman), the entire disclosures in which are incorporated herein by reference. A mobility and stabilization caddy having a caster assembly with omnidirectional roller balls is illustrated in FIGS. 11 and 12.

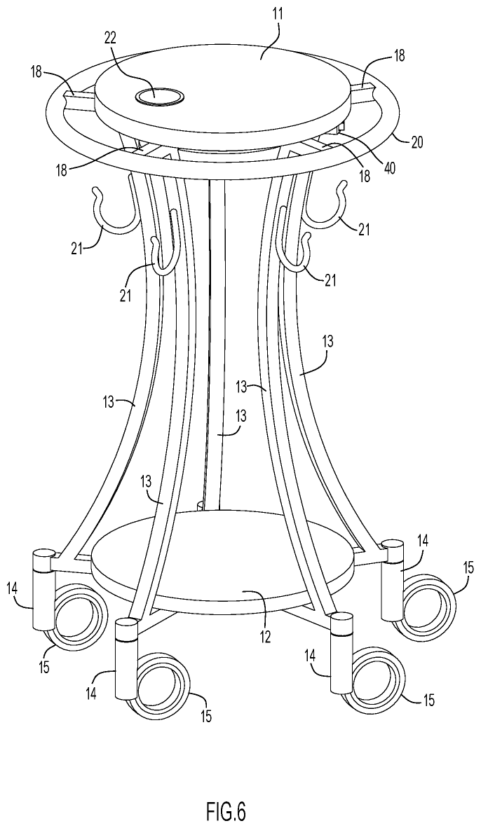

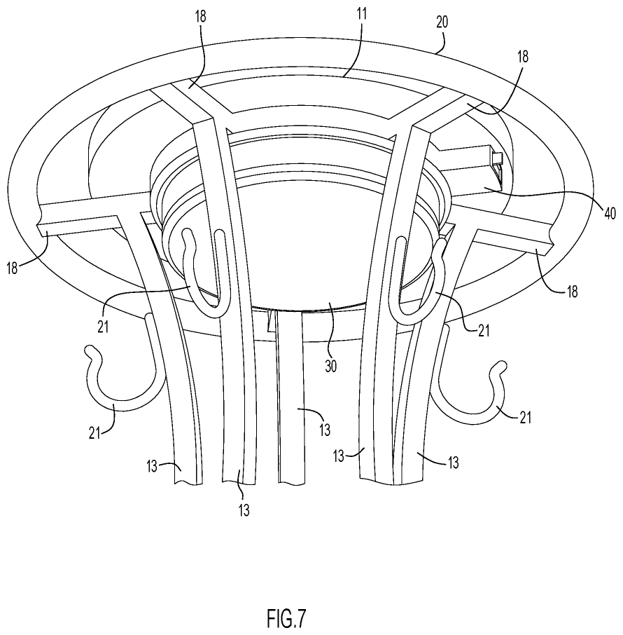

Although the four-leg caddy 10 illustrated in FIGS. 1-3 is sufficiently stable for most uses, if additional protection against tipping is desired, the angular spacing between the legs (and between their respective caster assemblies) may be reduced accordingly. Reducing the angular spacing minimizes the possibility of the caddy tipping by reducing the unsupported angular area between each wheel. That is, if a person grasping the annular grip 20 leans forcefully downward at a grip location above the space between the wheels, the resulting tipping force is applied over a much smaller unsupported angular area with a five-wheel arrangement than with four-wheel arrangement. The caddy 60 illustrated in FIG. 6 is provided with five equiangularly spaced legs (and wheels) successively spaced by 72°, whereas the spacing between the legs in caddy 10 is 90°.

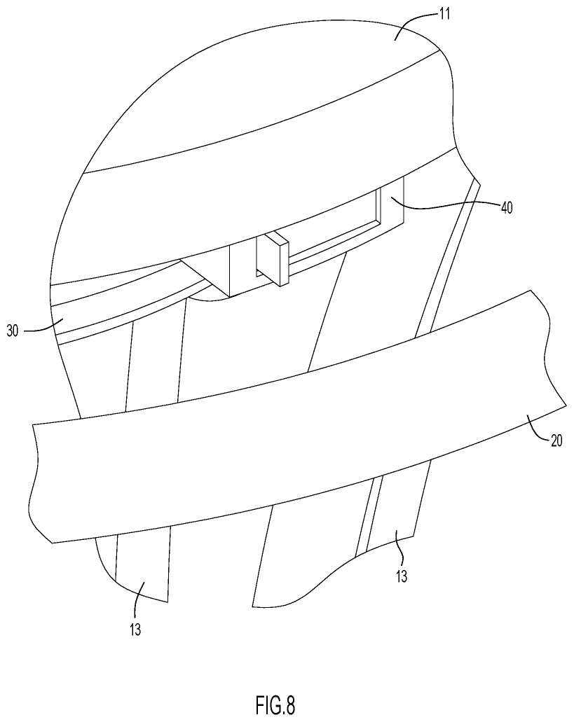

Referring to FIG. 7, secured to the bottom surface of table plate 11 (in caddy 10 and/or caddy 60) is an illumination unit 30 having a self-contained motion sensor and arranged to illuminate the floor area proximate caddy 10 upon detection of caddy motion or motion of a person or object in the immediate surroundings of the caddy. Such units are conventional and may monitor motion over 360° in a five to ten square feet area surrounding the caddy, with the capability of illuminating a similar floor area. The illumination source may be LEDs, and a brightness adjustment control may be included. In addition to illuminating the surrounding area to be navigated by a user, the motion detector unit senses motion by a user and provides lighting to enable the user to see and grasp grip 20 in a dark room. The illumination unit may be controlled by an electrical switch unit 40 which, as best illustrated in FIG. 8 may be a manually actuable switch unit mounted on the underside and near the peripheral edge of table plate 11. Switch unit 40 may be a three-position switch with an “off” position to deactivate illumination unit 30, an “on” position to cause the illumination unit to emit light, and a “motion” position to effect illumination when motion has been sensed. The motion sensor includes a pre-set time delay such that once it is actuated by sensed motion, illumination unit 30 remains activated for a predetermined time after motion is no longer sensed, typically five to ten seconds. It will be appreciated that the switch unit may be configured as part of the illumination unit.

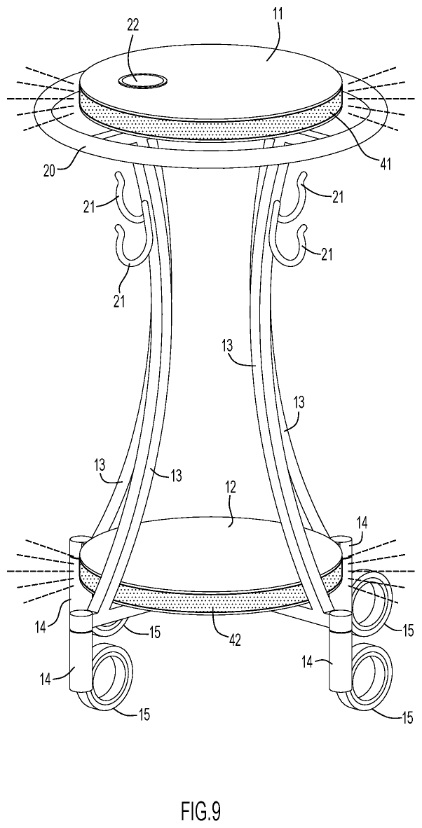

The illumination unit need not be mounted on the underside of table plate 11. For example, as illustrated in FIG. 9, an LED assembly configured as an elongated strip 41 of LEDs may be secured along the entire peripheral edge of table plate 11. Alternatively, or in addition, a like strip 42 of LEDs 12 may be secured along the entire peripheral edge of ballast plate 12.

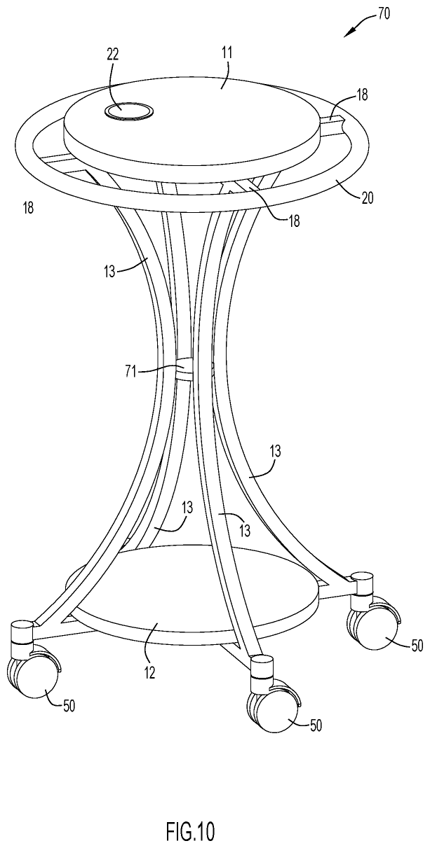

In the caddy embodiment 70 illustrated in FIG. 10, legs 13 are bowed to a greater extent than in caddy 10, and provide the caddy with greater structural integrity by means of a small circular leg connection plate 71. Plate 71 is oriented parallel to both the table plate 11 and ballast plate 12 and is positioned coaxially with those plates at a vertical location substantially equidistant from them. The peripheral edge of connection plate 71 is welded or otherwise rigidly connected to each of legs 13 at the apices of their curvature.

Referring to FIG. 11, a mobility and stabilization caddy 80 is shown with four legs 13, table plate 11 and ballast plate 12, as in caddy 10. In this embodiment the wheel caster assembly 82 is of the omnidirectional roller ball type with omnidirectional wheels 81 mounted for 360° rotatability in a generally cylindrical support secured to the bottom surface of ballast plate 12.

It will be appreciated that for some embodiments vertically extending legs 13 may be eliminated in favor of a conventional column or pedestal 90, as illustrated in FIG. 12. Pedestal 90 may have an ornamental configuration along its length and may diverge at its lower end to form a base section 92 comprising a plurality of angularly spaced radially extending legs 91. Respective caster assemblies 93 are secured to the underside of the legs proximate their radially outer ends. Base section 92 is of sufficient weigh to serve as a ballast for the unit.

The circular periphery of the caddy permits it to be moved in any direction by a user grasping grip 10 and pushing or pulling accordingly. This feature is particularly beneficial for patients who suffer from dementia, Parkinson's disease and neurological disorders that affect a person's body space awareness. In addition, the circular design provides for a tight turning radius that permits east maneuverability of the caddy in tight spaces.

Disclosed herein are embodiments of a tip resistant mobility and stabilization caddy having a table plate surrounded by an annular grip capable of being grasped by the hand of a patient at any point along its 360° periphery to stably support the patient transferring between sitting and standing positions and to permit the caddy to be easily guided and manipulated by the patient when walking. A plurality of angularly spaced legs support a like plurality of respective angularly spaced omnidirectional wheels. A weighted ballast base maintains a low center of gravity to resist tipping of the cavity.

The disclosed caddy's arcuate contour lines render it pleasing to the eye, the overall appearance being more like a piece of furniture rather than medical or institutional equipment.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A mobility and stabilization caddy comprising:
an upper table plate defining the upper end of said caddy and having top and bottom surfaces and a peripheral edge;
a plurality of at least four angularly spaced legs;
a plurality of at least four wheels, each wheel secured to a respective leg; and
a grip secured to said table plate in radially outward spaced relation to and surrounding said peripheral edge.

2. The mobility and stabilization caddy of claim 1, wherein said legs each have upper and lower ends, and wherein said table plate is secured to the upper ends of said legs.

3. The mobility and stabilization caddy of claim 2 further comprising a lower ballast plate vertically spaced below the table plate and secured to the caddy proximate the lower ends of the legs.

4. The mobility and stabilization caddy of claim 3 further comprising a light source secured to said table plate and positioned to illuminate an area surrounding and below said table plate.

5. The mobility and stabilization caddy of claim 4 further comprising a manually actuable switch secured to said table plate for electrically actuating said light source.

6. The mobility and stabilization caddy of claim 4 further comprising a motion sensor secured to said table plate for electrically actuating said light source in response to movement of said mobility and stabilization caddy.

7. The mobility and stabilization caddy of claim 4 wherein said top surface of said table plate is a high friction surface for resisting movement of objects thereon during normal movement of the caddy.

8. The mobility and stabilization caddy of claim 4 wherein said wheels are parts of respective self-braking caster assemblies omnidirectional, and are configured to be easily directionally manipulated in unison by a patient grasping said grip and forcefully moving said caddy.

9. The mobility and stabilization caddy of claim 3 wherein said table plate is circular, and wherein said grip is a hollow tube in the form of an annulus disposed concentrically about said table plate.

10. The mobility and stabilization caddy of claim 9 wherein said ballast plate is circular, and wherein said table and ballast and plates are concentrically aligned.

11. The mobility and stabilization caddy of claim 10 wherein said table and ballast plates and said legs are made of steel, and said caddy weighs at least twenty-five pounds.

12. The mobility and stabilization caddy of claim 10 wherein said legs are equiangularly spaced about a center point of said ballast plate.

13. The mobility and stabilization caddy of claim 12 wherein said plurality of legs is five legs.

14. The mobility and stabilization caddy of claim 12 further comprising at least one hook secured to one of said legs for supporting personal and medical items.

15. The mobility and stabilization caddy of claim 3 wherein said top surface of said table plate is a high friction surface for resisting movement of objects thereon during normal movement of the caddy, and further comprising a drinking cup holder defined in said top surface.

16. The mobility and stabilization caddy of claim 3 wherein said legs are longitudinally arcuately bent convexly toward one another.

17. A mobility and stabilization caddy comprising:
a table plate table having top and bottom surfaces and a peripheral edge;
a plurality of at least four equiangularly spaced legs having upper and lower ends, wherein the table plate is secured to the upper ends of said legs;
a ballast plate vertically spaced below and in coaxial alignment with the table plate, said ballast plate being and secured to the lower ends of the legs;
a plurality of at least four wheels, each wheel secured to the lower end of a respective leg; and
a grip secured to said table plate in radially outward spaced relation to and surrounding the peripheral edge of said table plate.

18. The mobility and stabilization caddy of claim 15 wherein said table plate is circular, and wherein said grip is a hollow tube in the form of an annulus disposed concentrically about said table plate.

19. The mobility and stabilization caddy of claim 16 further comprising a light source secured to said table plate and positioned to illuminate an area surrounding and below said table plate.

20. The mobility and stabilization caddy of claim 16 wherein said legs are longitudinally arcuately bent convexly toward one another.
